(19) United States
(12) Patent Application Publication
(10) Pub. No.: US 2008/0114752 A1
(43) Pub. Date: May 15, 2008

(54) QUERYING ACROSS DISPARATE SCHEMAS

(75) Inventors: Dustin G. Friesenhahn, Redmond, WA (US); Naresh Kannan, Seattle, WA (US); Robert G. Lefferts, Redmond, WA (US); W. Bruce Jones, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/759,465

(22) Filed: Jun. 7, 2007

Related U.S. Application Data
(60) Provisional application No. 60/859,051, filed on Nov. 14, 2006.

(51) Int. Cl. G06F 17/30

(52) U.S. Cl. 707/5; 707/E17.001

(57) ABSTRACT

Efficient querying across disparate schemas can be implemented by initially limiting the total number of lists and the total number of items queried and by using a mechanism for aligning data during the query. Querying across disparate data (e.g., data that is stored in accordance with disparate schemas) can comprise removing lists that are not applicable, defining a data alignment for the lists being searched, and executing the query.

### RELATED APPLICATION

This utility patent application claims the benefit under 35 United States Code §119(e) of U.S. Provisional Patent Application No. 60/859,051 filed on Nov. 14, 2006, which is hereby incorporated by reference in its entirety.

### BACKGROUND

Information is stored on various data systems for convenient access at a later time. However, the information is often stored in differing formats, even when similar systems are used. Also, many databases are user-created, which even further compounds the diversity of storage formats. Often, many types of data are stored all in a relatively large, but sparsely populated, database table. Other mechanisms of storing data include storing data in multiple tables each having a unique schema. The various approaches complicate the process of searching for desired data that is stored amongst different types of data.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Data can be stored and searched for in information systems using a list for representing the stored data. A list is typically a collection of items (e.g., rows in a table) which have properties (e.g., columns in a table). Some list examples include a set of personal contacts with properties (such as name, address, company), a set of parts with properties (such as cost or size), and a set of documents with properties (such as last modified time or author).

Database tables are commonly used for storing such data. For some applications, it is often necessary to create a single wide database table that is quite often only sparsely populated to store information (rather than by using separate tables to store the information). This is especially useful for generating large numbers of lists that can be defined because many database servers typically support many items in a table, rather than many different tables having few items. Such tables are often referred to as being a sparse database design, because many of the cells in the database are not populated.

Efficient querying across disparate schemas can be implemented by initially limiting the total number of lists and the total number of items queried and by using a mechanism for aligning data during the query. Querying across disparate data (e.g., data that is stored in accordance with disparate schemas) can comprise removing lists that are not applicable, defining a data alignment for the lists being searched, and executing the query.

These and other features and advantages will be apparent from a reading of the following detailed description and a review of the associated drawings. It is to be understood that both the foregoing general description and the following detailed description are explanatory only and are not restrictive. Among other things, the various embodiments described herein may be embodied as methods, devices, or a combination thereof. Likewise, the various embodiments may take the form of an entirely hardware embodiment, an entirely software embodiment or an embodiment combining software and hardware aspects. The disclosure herein is, therefore, not to be taken in a limiting sense.

### BRIEF DESCRIPTION OF THE DRAWINGS

FIG. 1 is an illustration of an example operating environment and system for querying across disparate schemas.

FIG. 2 is an illustration of two paradigms for storing data.

FIG. 3 is an illustration of overloading columns within a sparse data table design.

FIG. 4 is an illustration of a compacted sparse data table design.

FIG. 5 is a flow diagram illustrating an example query for data over a disparate data set.

FIG. 6 is an illustration of a data alignment table for aligning data of disparate data sets.

### DETAILED DESCRIPTION

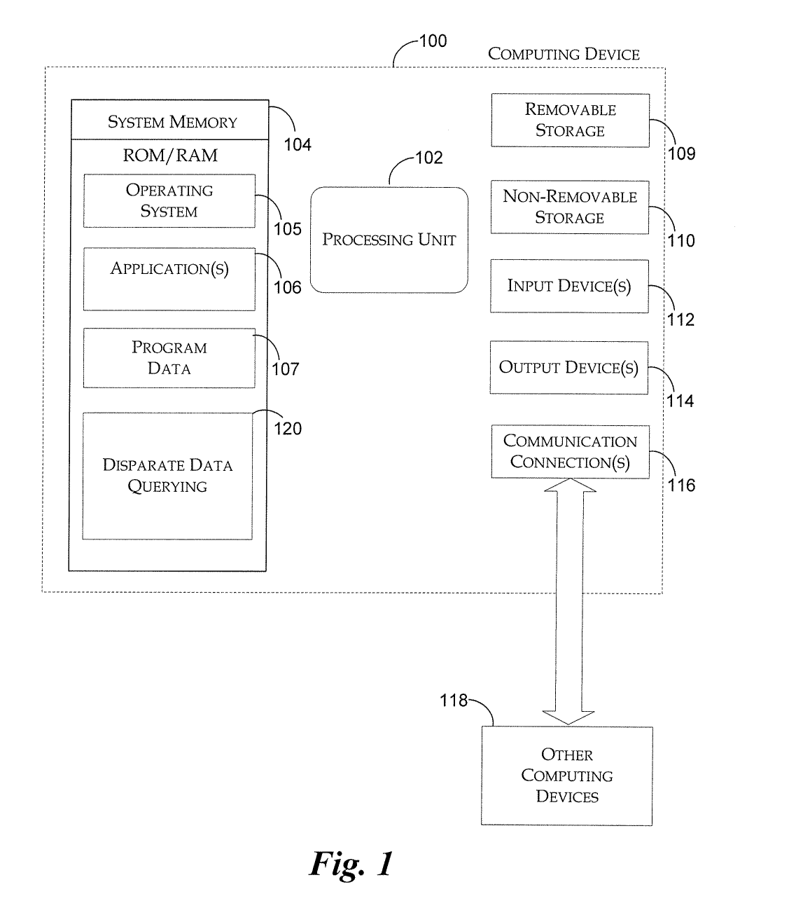

As briefly described above, embodiments are directed to dynamic computation of identity-based attributes. With reference to FIG. 1, one example system for expansion of list items for previewing includes a computing device, such as computing device 100. Computing device 100 may be configured as a client, a server, a mobile device, or any other computing device that interacts with data in a network based collaboration system. In a basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107 in which rendering engine 120, can be implemented in conjunction with processing 102, for example.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 1 10 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Networks include local area networks and wide area networks, as well as other large scale networks including, but not limited to, intranets and extranets. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

In accordance with the discussion above, computing device 100, system memory 104, processor 102, and related peripherals can be used to implement disparate data query engine 120. Disparate data querying engine 120 in an embodiment can be used to efficiently query data within sparse data tables (described below).

The disparate data query engine can query across disparate schemas by examining a query to determine lists that would be implicated by the search. The list of determined list can be used to exclude lists (and associated items) from the lists that are to be searched. An alignment table can be used for aligning data to implement the query.

Querying across disparate data (e.g., data that is stored in accordance with disparate schemas) can comprise removing lists that are not applicable, defining a data alignment for the lists being searched, and executing the query using the alignment table. The efficiency of the search is enhanced because data not implicated by the query is not searched.

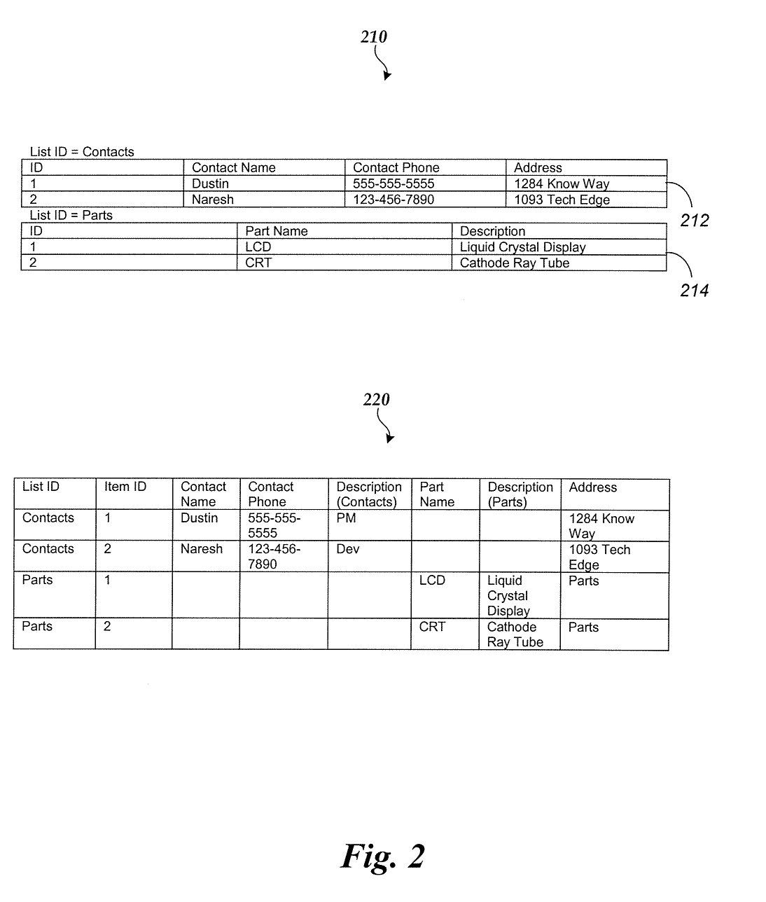

FIG. 2 is an illustration of two paradigms for storing data. Design 210 is a design that uses multiple tables (whereas design 220 is a sparse data table design). For example, design 210 comprises tables 212 and 214. Table 212 has a list identifier of “Contacts.” As illustrated, table 212 comprises four columns: an identifier (for identifying a contact item, which does not necessarily have to be unique), a contact name (such as a person's name), a contact phone number, and a physical address. The table is populated with two items, having identifiers of “1” and “2.”

Table 214 has a list identifier of“Parts.” As illustrated, table 214 comprises three columns: an identifier (for identifying a parts item, which does not necessarily have to be unique), a part name, and a description. The table is populated with two items, having identifiers of “1” and “2.”

Design 220 is a sparse data table design. For example, design 220 comprises eight columns: a list identifier (for identifying a list), an item identifier (which does not necessarily have to be unique), a contact name (such as a person's name), a contact phone number, a parts description, a part name, a parts description and a physical address.

The table is populated with four items, two each from tables 212 and 214. For example, items “1” and “2” from table 212 have been included, as well as items “1” and “2” from table 214 have been included. It can be seen that various cells remain unpopulated, which is a characteristic of sparse data table designs. Moreover, it can be seen that as more unrelated (or partially related) data is added, the unpopulated cells occur even more frequently (which is often due to lack of commonality in column types).

In some cases, the actual schema of the data to be stored can be user-defined and/or dynamically instantiated in the application. Thus, the initial table design might be fixed, but the actual values stored in each column could vary based on a user's scenario. A user can use Name Values Pairs (NVPs) for specifying what type of data from the lists can be used to create indexes.

For example, which columns hold which data in a sparse data table design is typically determined by the list (within the overall table) to the data belongs. One row (from a first list) might use “Integer1” for the size of the item, and another row (from a second list) might also use “Integer1” for the cost of an item. The schema that is being used would be typically determined by consulting which particular list host a particular item.

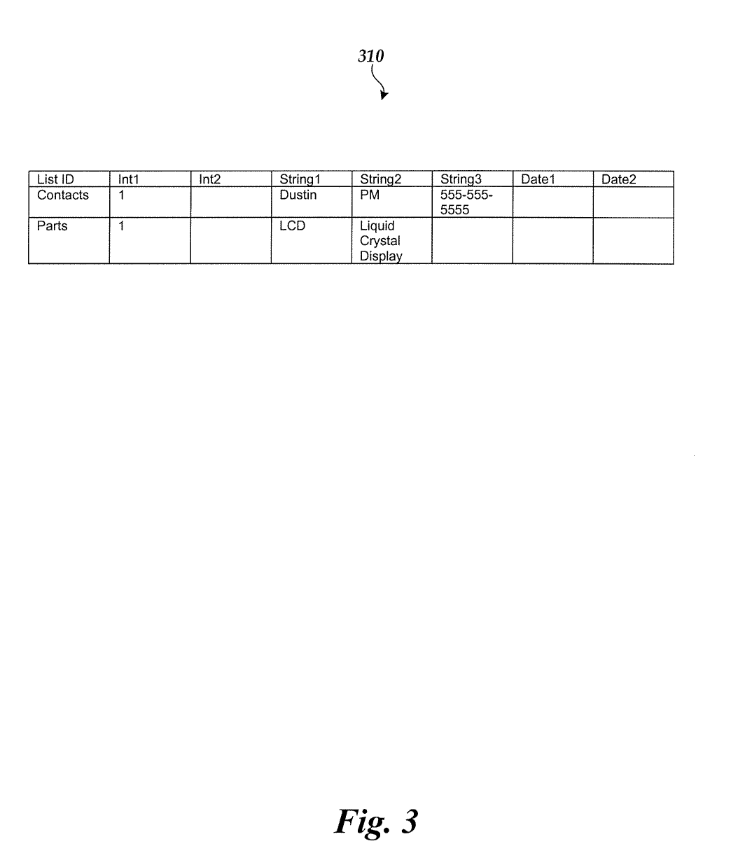

FIG. 3 is an illustration of overloading columns within a sparse data table design. For example, design 310 comprises eight columns: a list identifier (for identifying a list), Int1 (a first integer), Int2 (a second integer), String1 (a first string), String2 (a second string), String3 (a third string), Date1 (having a “date” data format), and Date2.

Data from different lists (such as from tables 112 and 114) can be stored in a more compact form by sharing columns having compatible data types (such as integer, string, date, and the like). For example, a column having a data type of integer can be used to hold a list number. In similar fashion, a column having a data type of string can be used to hold string data such as contact name, part name, job description, part description, phone number, address and the like.

Trying to query across this data can be difficult since no one column contains data that is aligned to a schema of a particular list. There may also be many lists in the table that are not relevant to the query, or that contain no items that are relevant to the query. Also, data is often stored in a de-normalized fashion, such that a logical “item” has data spread out in different locations (in separate tables, for example). Two schemas may define this separation in different ways, which require queries of different forms. Such data can be efficiently queried by first limiting (or otherwise qualifying) the total number of lists queried, and then aligning the data being queried.

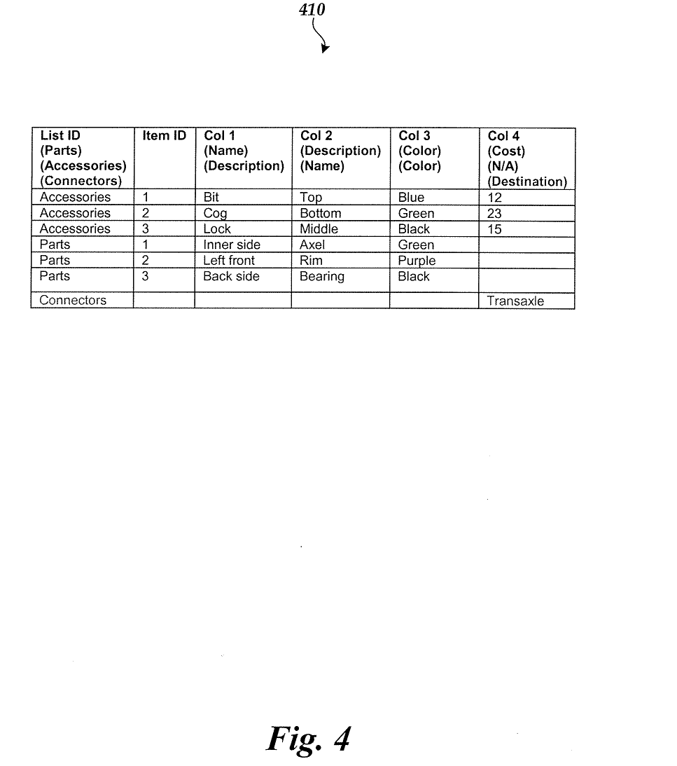

FIG. 4 is an illustration of a compacted sparse data table design. As shown in the List ID column of table 410, three lists of data are stored (Accessories, Parts and Connectors). As shown also, each column in the table has slightly different characteristics. For example, two of the lists (Parts and Accessories) have a Name and Description.

The characteristics for items of these lists are stored in Cols. 1 and 2, except with reverse column orders (with respect to the opposing list). Col. 3 has data for the color which is uniform across the lists except for Connectors. Moreover, Col. 4 has data on the Cost (which only applies to items in the Accessories list), and Destination (which only applies to items in the Connectors list).

It may also be convenient to organize selected lists from the table into groups. The groups can be labeled with (for example) a group identifier. For example, the lists Parts and the list Accessories can be combined into a single group (Car Items, for example). Grouping can be used to facilitate searching amongst lists that originate from, for example, a single web site.

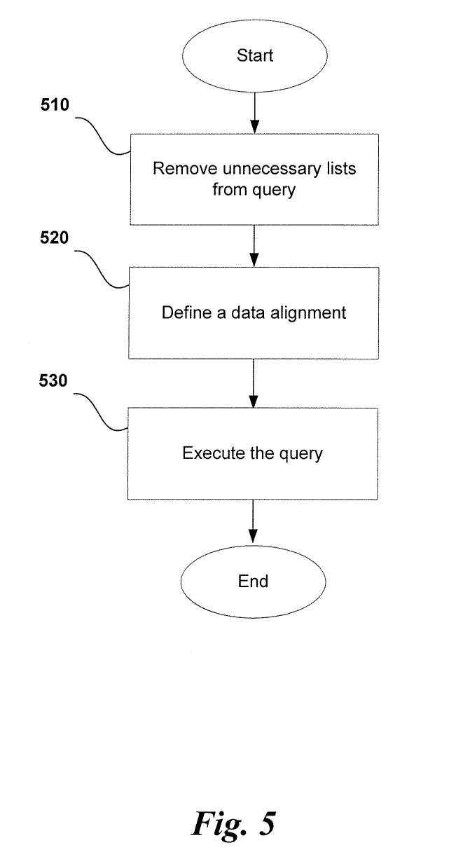

FIG. 5 is a flow diagram illustrating an example query for data over a disparate data set. For example, three operations can be performed over the data in table 410. In the example, the query can be used to find the Name, description, and Color of all the items in the Parts or Accessories lists.

In operation 510, unnecessary lists are typically removed from the query. When querying for Parts or Accessories, items that are not in the defined list type (Parts or Accessories) are not normally consulted. While the query normally explicitly defines which lists to use or not use, other methods can be used to determine and/or to identify entire lists to omit. For example, an index can be made which can efficiently indicate whether if certain items in the list are going to produce results. This index could determine whether the Connectors list has items that do not have Name, Description, or Color, and thus decide to skip that entire set of data. Thus, removing unnecessary lists reduces the total number of lists that are queried.

In another example, it is possible that a query author might wish to define a query to include even those lists which were missing one or more of the fields referenced. In such queries, results can be given by returning empty data for missing fields. The query author can thus define queries which take advantage of both behaviors.

For example, one form of the query syntax can “discover” lists that are associated with a certain field by following indexes in the schema by starting from the field name (or field ID, more precisely) and by following links to discovers lists that are associated with the specified field. This implementation usually requires the field to be indexed, which typically improves performance for queries that rely on a particular field.

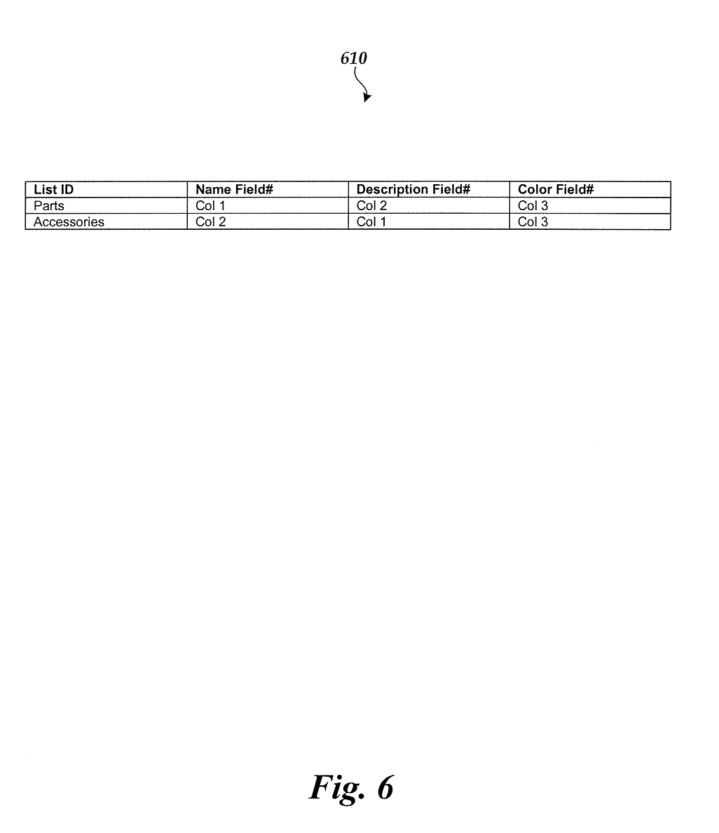

In operation 520, the data alignment is defined. FIG. 6 is an illustration of a data alignment table. Table 610 is generated in response to a query for items from lists Parts and Accessories and (optionally) comprising Name, Description, and Color characteristics. Accordingly table 610 comprises four columns having List ID, Name Field number, Description Field number, and a Color Field number. Each list from the query (Parts and Accessories) has an associated row wherein the cells contain links to columns that potentially contain searched-for data.

Table 610 contains a mapping of each field to the place it is actually stored depending on which list of data being searched. Although, for simplicity of explanation, the example shows the lists as being comprised by a single table, the mapping might instead point to other locations (such as separate tables). Accordingly, the alignment table can be used to store a pointer to where the data actually resides.

As described above, differences in the structure of the query may need to be resolved. As an example, a design can include the Parts and Accessories lists and includes a Vendor field, but that the Vendor data is actually stored in a separate list. The Parts list's Vendor data is stored in the Manufacturers, while the Accessories list's Vendor data refers to the Designers list. A query over the Parts list that includes the Vendor field will have a different structure than a similar query over the Accessories list, because the Vendor data is in a different location.

Such differences can be resolved by including an additional column in the alignment table that identifies the target list. When structural differences in the query cannot be easily resolved, a query can be constructed for combining each of the individual result sets from otherwise incompatible queries.

For example, the SQL UNION statement can be used to combine potential result sets from the otherwise incompatible queries. The result sets can be manipulated using other logical/set operations such as AND, NOT, OR, XOR, INTERSECTION, ELEMENT, and the like to logically combine result sets. A different alignment table can be constructed for each query for which the result sets are to be combined.

Referring again to FIG. 5, the query can be executed as illustrated by operation 530. For example, the query can be executed across table 410 (which comprises a set of data to be searched). Using lists that are implicated in operation 510, the alignment table is referenced to locate columns containing the actual data to be searched.

For example, the query can be executed using the following parameters. The logical conditions can be used to specify that the List ID is equal to “Parts” or “Accessories” in response to operation 510, for example. The data to be returned can be specified as “Name,” “Description,” and “Color.” The columns to be pointed to by the alignment table can be specified as “Alignment[ListID].Name,” “Alignment[ListID].Description,” and “Alignment[ListID] Color.”

The result set of the query can be sorted by one of the shared columns. For example, sorts can be applied using a specified permutation of the columns. Additionally, other sorts can be used, such as by grouping the items in accordance with the containing list of the items.

For example, results from a query for items occurring within a range of dates can be given. Lists (contained within a dataset) not having dates associated therewith can be put in an “exclude” list. An alignment table can be constructed using lists that are not in the exclude list. The sorting can be made efficient by sorting the lists in the table first, then by the fields, and then by the value. By sorting by value last, all of the rows in the alignment table are in date order, which increases the efficiency of queries looking for fields and lists that are associated with a range of dates.

The above specification, examples and data provide a complete description of the manufacture and use of embodiments of the invention. Since many embodiments of the invention can be made without departing from the spirit and scope of the invention, the invention resides in the claims hereinafter appended.

We claim:

1. A computer-implemented method for querying data stored in accordance with disparate schema, comprising:
evaluating a search query to determine which lists in the stored data comprise fields that are implicated by search terms in the search query;
defining a data alignment table in response to the evaluation wherein the data alignment table comprises entries for the implicated lists, wherein each entry is associated with a list name and a field of the named list; and
using the entries of the data alignment table to execute the query.

2. The method of claim 1 wherein the stored data is stored in a sparse data table format.

3. The method of claim 1 wherein the stored data is stored in a compact data table format.

4. The method of claim 1 wherein the entry association is a link to a column of data entries in a list.

5. The method of claim 1 further comprising sorting the entries of the data alignment table.

6. The method of claim 5 wherein the sorting comprises sorting in accordance with field data.

7. The method of claim 5 wherein the sorting comprises sorting in accordance with the list names.

8. The method of claim 5 wherein the sorting comprises sorting in accordance with field data and sorting in accordance with the list names.

9. The method of claim 1 wherein the alignment table excludes lists that do not have fields specified in the query.

10. The method of claim 1 further comprising executing a second query using entries of the data alignment table.

11. The method of claim 1 further comprising executing a second query using a second data alignment table.

12. The method of claim 11 further comprising logically combining the results of the query and the second query.

13. The method of claim 1 wherein the stored data is stored in columns wherein at least one of the columns stores data of the same type from different lists.

14. A system for querying data stored in accordance with disparate schema, comprising:
a user interface for receiving a user query for search for data in a structure having multiple lists, wherein each list has an arbitrary schema for defining fields that are associated with each list;
a data structure evaluator for determining data dependencies in the structure a query parser for determining lists that are implicated by a query and by the determined data dependencies;
a data alignment table constructor for constructing an alignment table that comprises entries for the implicated lists, wherein each entry is associated with a list name and a field of the named list; and
a query execution unit for using entries from the data alignment table to execute queries.

15. The system of claim 14 wherein the stored data is stored in columns wherein at least one of the columns stores data of the same type from different lists.

16. The system of claim 14 wherein the query identifies the columns to be searched.

17. The system of claim 16 wherein the query identifies the lists to be searched.

18. A tangible computer readable medium comprising instructions for querying data stored in accordance with disparate schema, comprising:
displaying a user interface for displaying the disparate schema and for receiving a search query from a user formed in response to the displayed disparate schema;
evaluating the search query to determine which lists in the stored data comprise fields that are implicated by search terms in the search query;
defining a data alignment table in response to the evaluation wherein the data alignment table comprises entries for the implicated lists, wherein each entry is associated with a list name and a field of the named list; and
using the entries of the data alignment table to execute the query.

19. The method of claim 18 further comprising instructions for displaying results on the user interface wherein a representation for empty data is displayed to represent missing fields.

20. The method of claim 18 further comprising instructions for logically combining the results of the search query and a second query.
